(19) United States
(12) Patent Application Publication
(10) Pub. No.: US 2016/0129818 A1
(43) Pub. Date: May 12, 2016

(54) VEHICLE SEAT

(71) Applicant: TOYOTA BOSHOKU KABUSHIKI KAISHA, Aichi-ken (JP)

(72) Inventor: Hideo SAHASHI, Komaki-shi (JP)

(73) Assignee: TOYOTA BOSHOKU KABUSHIKI KAISHA, Aichi-ken (JP)

(21) Appl. No.: 14/931,247

(22) Filed: Nov. 3, 2015

(30) Foreign Application Priority Data
Nov. 7, 2014 (JP) 2014-226753

(51) Int. Cl. B60N 2/58; B60N 2/70

(52) U.S. Cl. CPC B60N 2/5825; B60N 2/70

(57) ABSTRACT

A vehicle seat includes: a seat pad including, on its front surface, a recess-shaped portion; and a seat cover fixed to the recess-shaped portion so as to be tacked into the recess-shaped portion. The seat pad includes a coupling groove provided on the recess-shaped portion and having a bottom face portion formed on a curved surface extending along a front surface of the recess-shaped portion. A plurality of locking members is disposed at predetermined positions on the bottom face portion at intervals. Part of a coupling member attached to a back surface of the seat cover is locked to the plurality of locking members so as to be fixed thereto.

### INCORPORATION BY REFERENCE

The disclosure of Japanese Patent Application No. 2014-226753 filed on Nov. 7, 2014 including the specification, drawings and abstract is incorporated herein by reference in its entirety.

### BACKGROUND OF THE INVENTION

1. Field of the Invention

The present invention relates to a vehicle seat.

2. Description of Related Art

In terms of a vehicle seat, when a seat cover, which is a skin material, is fixed to a surface of a seat pad, which is a cushioning material, a coupling member such as fabric or resin attached to a back surface of the seat cover is pulled into a coupling groove provided in the seat pad, so as to be fixed thereto. In a case where a front surface of the seat pad that supports a body of a sitting person is formed in a recessed shape, there is such a structure that a bottom face of the coupling groove is also formed in a curved shape and the coupling member is locked, by a hook ring, to an insert wire disposed therein. In a seat-cover coupling structure for a vehicle seat, as described in Japanese Utility Model Application Publication No. 3-120900 (JP 3-120900 U), an insert wire is molded in a curved shape along a bottom-face shape of a coupling groove in advance, and insert-molded in a seat pad.

### SUMMARY OF THE INVENTION

In the technique described in JP 3-120900 U, there is such a problem that, when the insert wire is molded in a curved shape along the bottom-face shape of the coupling groove in advance, a highly accurate machining step in consideration of spring back is required.

The present invention provides a vehicle seat in which a seat cover is fixed, so as to be tacked into a seat pad having a front surface formed in a recessed shape and which has a structure that can be manufactured in a simple step.

A vehicle seat according to an aspect of the present invention includes: a seat pad including, on its front surface, a recess-shaped portion with respect to a sitting person; and a seat cover covering the seat pad and fixed to the recess-shaped portion so as to be tacked into the recess-shaped portion. The seat pad includes a coupling groove provided on the recess-shaped portion and having a bottom face portion formed on a curved surface extending along a front surface of the recess-shaped portion. A plurality of locking members is disposed at predetermined positions on the bottom face portion at intervals. Part of a coupling member attached to a back surface of the seat cover is locked to the plurality of locking members so as to be fixed thereto.

According to the above aspect, part of the belt-shaped coupling member attached to the back surface of the seat cover is locked to each of the plurality of locking members disposed at intervals on a bottom face of the coupling groove. Hereby, each of the locking members is just disposed at a predetermined position on the bottom face portion of the coupling groove provided on the front surface of the seat pad. That is, a highly accurate machining step of molding an insert wire in a curved shape in advance becomes unnecessary.

Further, in the above aspect, the bottom face portion may be configured such that its longitudinal central line is a curved line both in a front view and a side view of the recess-shaped portion of the seat pad.

The longitudinal center line of the bottom face portion of the coupling groove has a complicated three-dimensional curved line shape. Accordingly, in order to mold an insert wire in a curved shape in advance, further highly accurate machining is required. However, according to the above configuration, such a machining step can be made unnecessary.

Further, in the above aspect, the locking members may be clips made of resin.

According to the above configuration, metal members such as an insert wire and a hook ring are not used, thereby making it possible to achieve lightweighting.

Further, in the above aspect, the coupling member may be a belt-shaped body made of resin or a belt-shaped body in which a resin columnar body is integrally attached, along its longitudinal direction, to one side portion of a belt-shaped fabric body along the longitudinal direction.

According to the above configuration, metal members such as a coupling wire are not used, thereby making it possible to further achieve lightweighting.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view illustrating a vehicle seat according to one embodiment of the present invention;

FIG. 2 is an exploded perspective view of a back pad and a back cover of a seatback according to the embodiment, when viewed from a diagonal front side;

FIG. 3 is a front view of the back pad according to the embodiment;

FIG. 4 is a sectional view taken along an arrow IV-IV in FIG. 3;

FIG. 5 is a sectional view taken along an arrow V-V in FIG. 1;

FIG. 6 is a sectional view taken along an arrow VI-VI in FIG. 3, and also illustrates a section of the back cover;

FIG. 7 is a perspective view of a suspender according to the embodiment; and

FIG. 8 is a perspective view of a clip according to the embodiment.

### DETAILED DESCRIPTION OF EMBODIMENTS

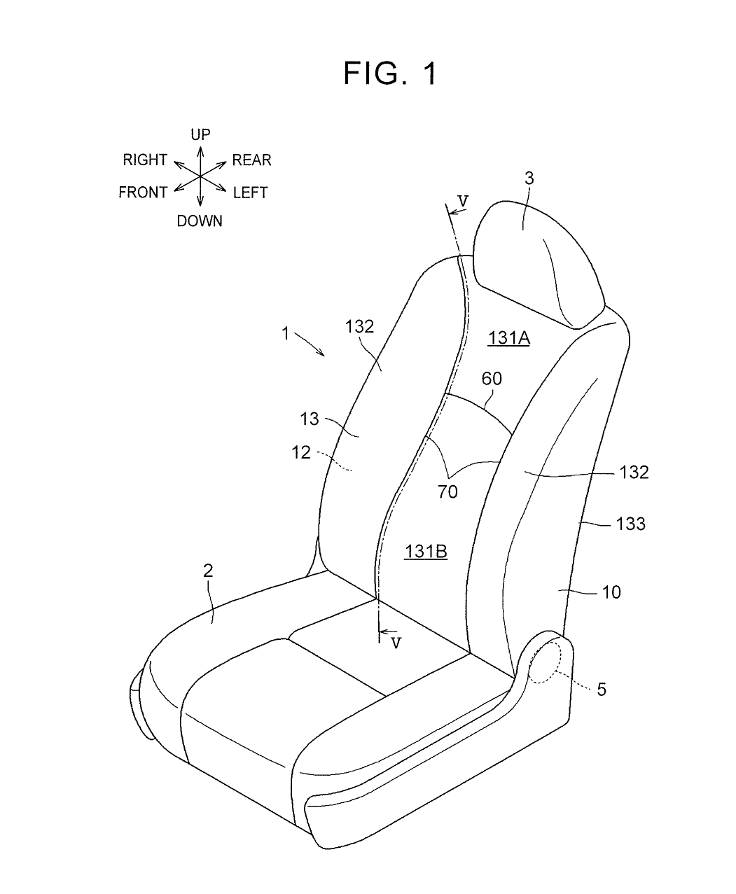

FIGS. 1 to 8 illustrate one embodiment of the present invention. This embodiment is an example in which the present invention is applied to a seatback of an automotive seat. In each of the figures, each direction of an automobile at the time when the automotive seat is attached to the automobile is indicated by an arrow. In the following description, a description about directions shall be made on the basis of the above directions. An automotive seat 1 of the present embodiment includes a seat cushion 2 serving as a seat portion, a seatback 10 serving as a backrest, and a headrest 3 for supporting a head. The seatback 10 is configured such that lower ends on both sides thereof are respectively connected to rear ends of the seat cushion 2 via a recliner 5. The seat cushion 2, the headrest 3, and the recliner 5 have well-known configurations, so that descriptions thereof are omitted, and the following describes the seatback 10.

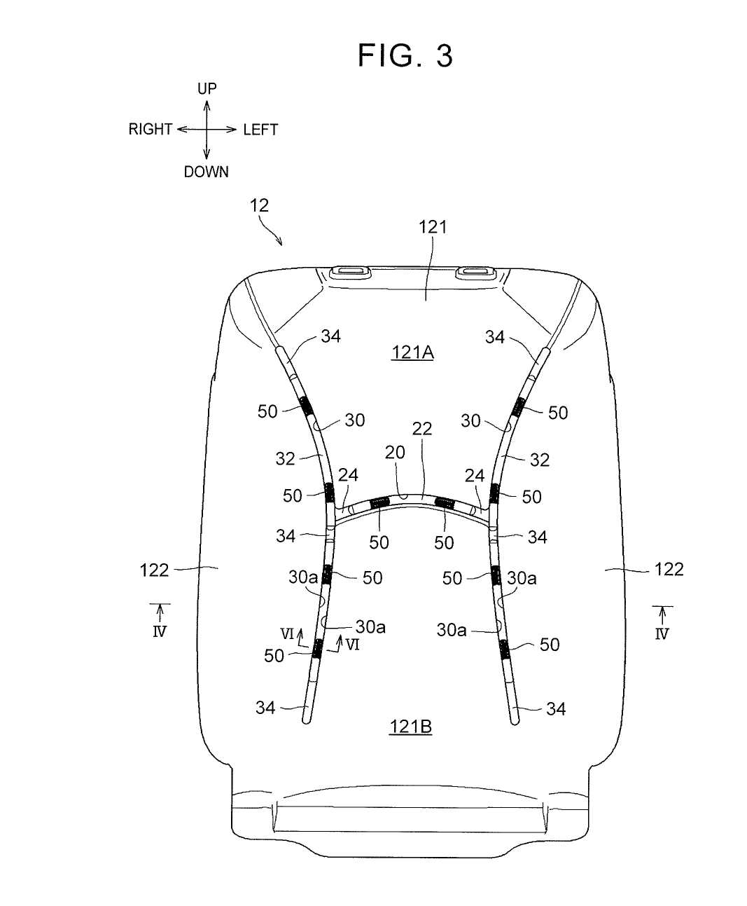

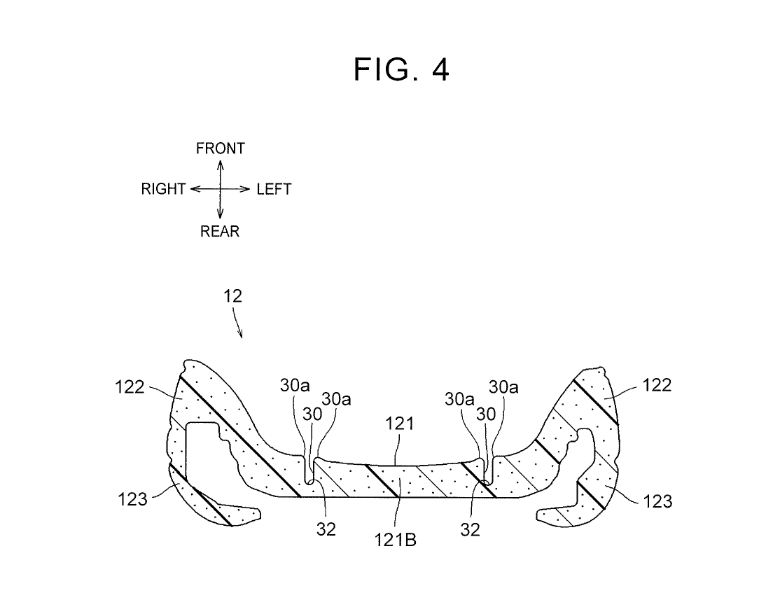

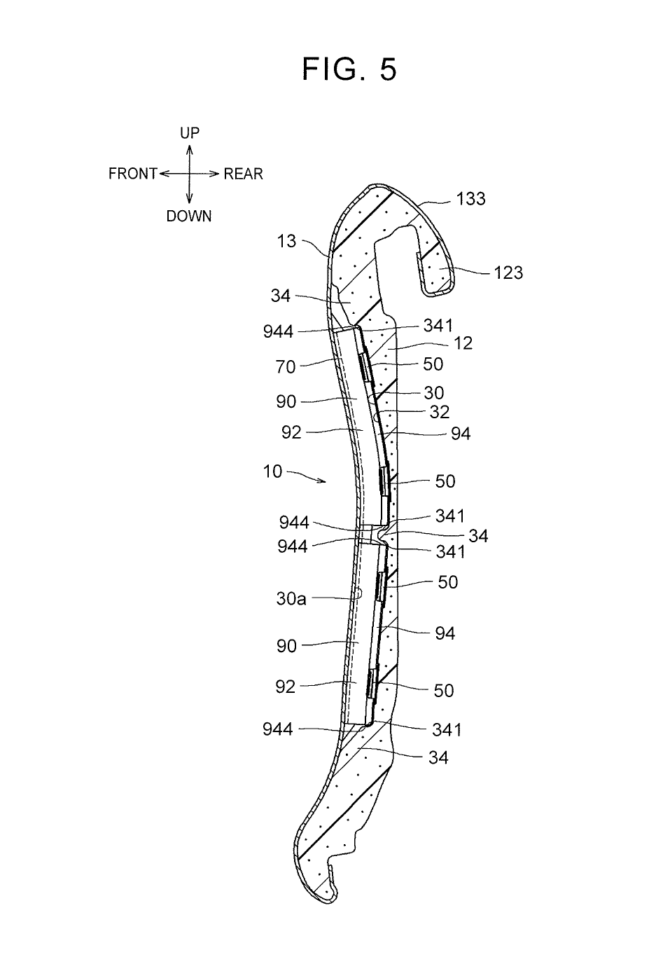

The seatback 10 has a structure in which a back pad 12, which is a cushioning material, is placed on a back frame (not shown) that forms a framework of the seatback 10, and a back cover 13, which is a skin material, is put over the back pad 12 so as to cover the back pad 12. As illustrated in FIG. 3, the back pad 12 mainly includes a sitting face portion 121 having a recess-shaped sitting face with which a back of a sitting person abuts, and mound portions 122 for supporting side parts of the sitting person. The sitting face portion 121 includes a central upper part 121A for supporting an upper part of the back of the sitting person, and a central lower part 121B for supporting a lower part of the back of the sitting person. The mound portions 122 are placed on both right and left outer sides of the sitting face portion 121, and each have a projecting shape that projects forward relative to the sitting face portion 121. Further, as illustrated in FIGS. 4 and 5, the back pad 12 includes an enclosing portion 123 extending so as to turn back toward a rear side from upper, lower, right, and left peripheral parts of the sitting face portion 121, and right and left peripheral parts of the mound portions 122. In a state where the enclosing portion 123 covers a back frame, the back pad 12 is attached to the back frame. The back pad 12 is an example of a “seat pad” in Claims.

As illustrated in FIG. 3, a lateral coupling groove portion 20 is provided in a recessed manner in a boundary part, in an up-down direction, between the central upper part 121A and the central lower part 121B of the sitting face portion 121. In a front view of the back pad 12, the lateral coupling groove portion 20 is extended in a seat-width direction in a state where the lateral coupling groove portion 20 is curved so that its center in the seat-width direction projects uppermost. A vertical coupling groove portion 30 is provided in a recessed manner in a boundary part between the central upper part 121A and the mound portion 122 and in a boundary part between the central lower part 121B and the mound portion 122. In a front view of the back pad 12, the vertical coupling groove portion 30 is extended in the up-down direction in a state where the vertical coupling groove portion 30 is curved so as to project inward in the seat-width direction. A vicinal area of an intermediate part of the vertical coupling groove portion 30 is connected to an end portion of the lateral coupling groove portion 20 in an extending direction (the seat-width direction). A bottom face portion 22 of the lateral coupling groove portion 20 and a bottom face portion 32 of the vertical coupling groove portion 30 are each provided with corresponding positioning projection portions 24, 34, and locking clips 50.

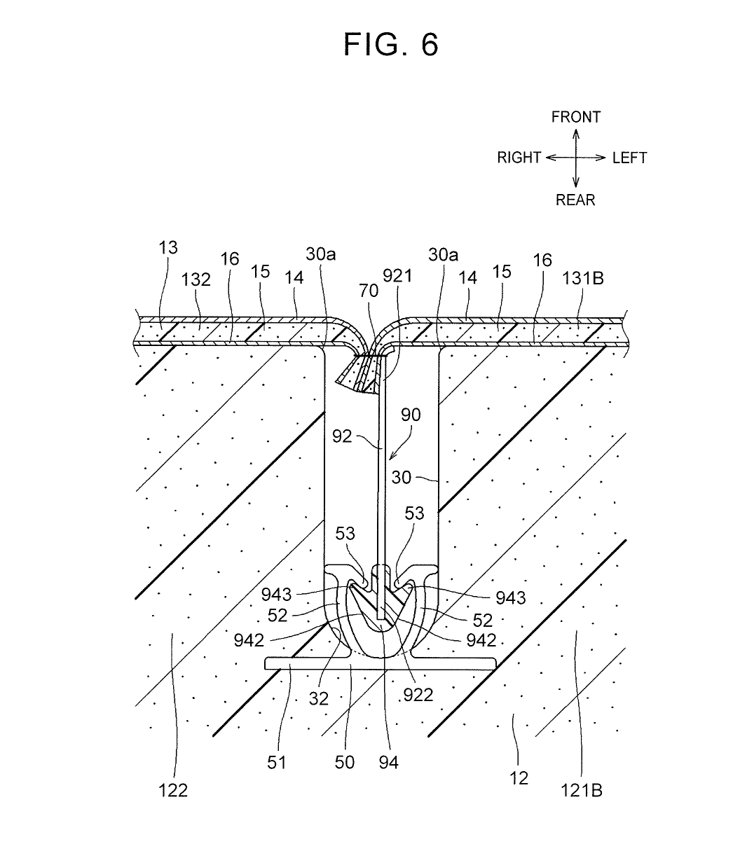

Since the lateral coupling groove portion 20 and the vertical coupling groove portion 30 have a similar structure, the following describes the vertical coupling groove portion 30 as a representative. In terms of the vertical coupling groove portion 30, a section cut along a position corresponding to a groove center line in FIG. 1 is illustrated in FIG. 5. As illustrated in FIGS. 5 and 6, the vertical coupling groove portion 30 is configured such that an opening end portion 30a that constitutes a part of a sitting face is curved in a direction recessed toward a sitting person, and the bottom face portion 32 is also curved in the direction recessed toward the sitting person along the opening end portion 30a. A depth of the groove, that is, a distance between the opening end portion 30a and the bottom face portion 32 is generally uniform from an upper end of the vertical coupling groove portion 30 to a bottom end thereof, and is about two-thirds of a thickness of the back pad 12. Further, as illustrated in FIGS. 4 and 6, that section of the vertical coupling groove portion 30 which is cut in the seat-width direction is formed in a generally U-shape. Four locking clips 50 are disposed in predetermined parts of the bottom face portion 32, generally at regular intervals along the groove. That is, two locking clips 50 are disposed in the vertical coupling groove portion 30 between the central upper part 121A and the mound portion 122 and two locking clips 50 are disposed in the vertical coupling groove portion 30 between the central lower part 121B and the mound portion 122, and thus four locking clips 50 in total are disposed. The vertical coupling groove portion 30 is an example of a “coupling groove” in Claims.

As illustrated in FIGS. 6 and 8, the locking clip 50 is a molded resin product, and includes a flat-shaped leg portion 51 buried in the bottom face portion 32 of the vertical coupling groove portion 30, and a pair of arm portions 52 projecting forward (in a direction toward a sitting face side) from the leg portion 51. The arm portions 52 are provided in a state where they are exposed in the groove from the bottom face portion 32 of the vertical coupling groove portion 30. The arm portions 52 are opposed to each other and each include a claw portion 53 projecting from its front end toward a direction of the other arm portion 52. A gap dimension between tip ends of the claw portions 53 is set to be narrower than a width of an overhanging portion 943 of a resin columnar body 94 of a suspender 90 (a coupling member). The locking clips 50 are molded integrally with the back pad 12 such that, in a state where the locking clips 50 are placed at their corresponding parts in a cavity of a molding die for the back pad 12, a liquid urethane resin material before hardening is poured into the cavity and subjected to foam molding. The locking clip 50 is an example of a “locking member” in Claims.

The positioning projection portions 34 are each provided in a state where the bottom face portion 32 of the vertical coupling groove portion 30 locally projects forward (in a direction toward the sitting face side), so as to perpendicularly rise relative to the bottom face portion 32. As illustrated in FIG. 5, a height of the positioning projection portion 34 of the vertical coupling groove portion 30 is a height at which its side face portion 341 can abut with a whole area of a side face portion 944 of the resin columnar body 94 that is held engaged with the locking clips 50 in the vertical coupling groove portion 30. As illustrated in FIGS. 3 and 5, the positioning projection portions 34 of the vertical coupling groove portion 30 are disposed in three parts of the vertical coupling groove portion 30, i.e., in both end parts thereof in an extending direction (the up-down direction) and in the vicinal area of the intermediate part thereof in the extending direction. The positioning projection portions 34 are made of a urethane foam material, and are molded simultaneously at the time of molding of the back pad 12.

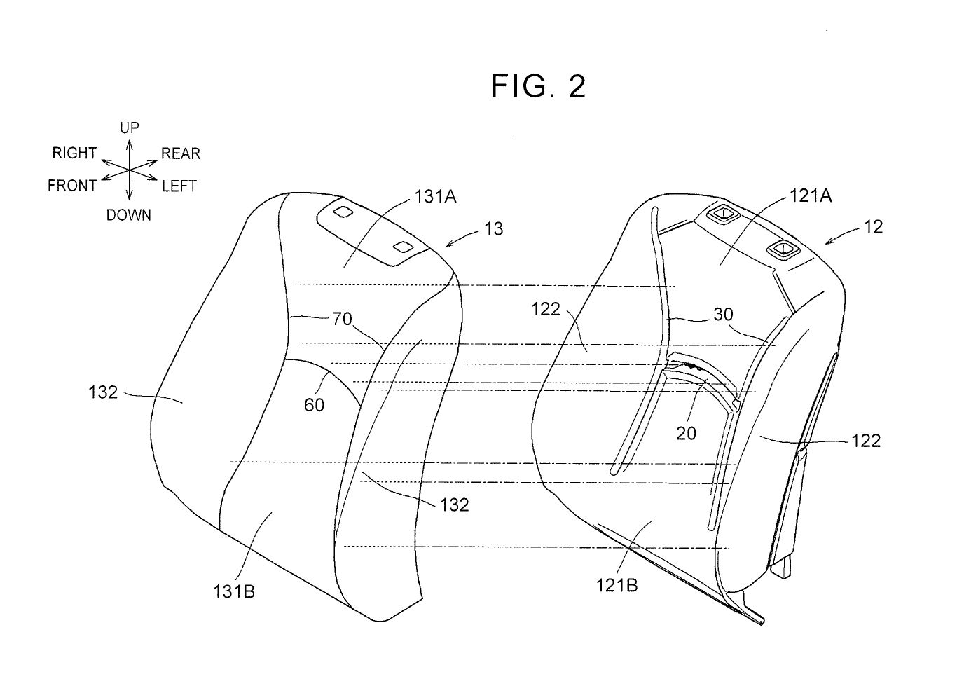

The back cover 13 fixes the back pad 12 by pressing the back pad 12 against the back frame by its stretching force. As illustrated in FIG. 6, the back cover 13 is formed as a laminated member including a skin 14, which is fabric having air permeability, a laminated pad 15 made of urethane foam slab and attached onto a back surface of the skin 14, and a back base fabric 16 attached onto a back surface of the laminated pad 15. As illustrated in FIGS. 1 and 2, the back cover 13 is formed in an integrated manner by sewing together a central upper cover 131A, a central lower cover 131B, mound portion covers 132, and an enclosing portion cover 133. The central upper cover 131A, the central lower cover 131B, the mound portion covers 132, and the enclosing portion cover 133 correspond to the central upper part 121A, the central lower part 121B, the mound portions 122, and the enclosing portion 123 of the back pad 12, respectively. Accordingly, a lateral sewn portion 60 is formed in the back cover 13 at a position corresponding to the lateral coupling groove portion 20, and a vertical sewn portion 70 is formed at a position corresponding to the vertical coupling groove portion 30 and a part downward from a lower end of the vertical coupling groove portion 30. As illustrated in FIG. 5, the vertical sewn portion 70 is fixed in a state where the vertical sewn portion 70 is drawn into the vertical coupling groove portion 30. The back cover 13 is an example of a “seat cover” in Claims.

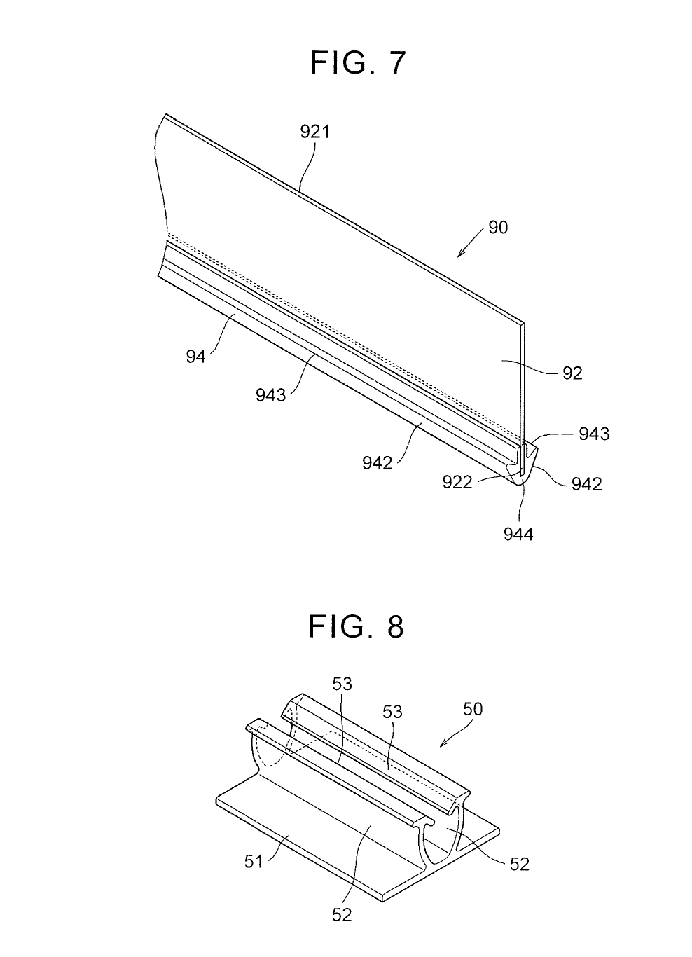

The suspender 90 is attached to a back surface of the back cover 13. As illustrated in FIGS. 6 and 7, the suspender 90 includes a belt-shaped fabric body 92 made of nonwoven fabric, and a resin columnar body 94 attached to one side portion 922 of the belt-shaped fabric body 92 in a longitudinal direction. The suspender 90 is formed in an integrated manner such that the belt-shaped fabric body 92 having a given width is supplied while the resin columnar body 94 having an arrowhead-shaped section is extruded. As illustrated in FIG. 6, the suspender 90 is attached to the back surface of the back cover 13 such that the other side portion 921 of the belt-shaped fabric body 92 in the longitudinal direction and the sewn portion 70 of the back cover 13 are sewn together. The suspender 90 is an example of a “coupling member” in Claims.

The following describes a procedure of locking the suspender 90 to the locking clips 50. As illustrated in FIG. 5, each side face portion 944 of the resin columnar body 94 of the suspender 90 attached to the back surface of the back cover 13 is caused to abut with the side face portion 341 of each positioning projection portion 34 so as to position the suspender 90 relative to the vertical coupling groove portion 30. In this state, when the resin columnar body 94 of the suspender 90 is inserted between the claw portions 53 of each locking clip 50, the arm portions 52 of the locking clip 50 are pressed and expanded by a tapered portion 942 of the resin columnar body 94, so that the claw portions 53 of the locking clip 50 are distanced from each other. When the overhanging portions 943 of the resin columnar body 94 are inserted over the claw portions 53 of the locking clip 50, the arm portions 52 of the locking clip 50 are back, from elastic deformation, to a previous state before they are pressed and expanded, so that the overhanging portions 943 are caught on the claw portions 53. Hereby, the resin columnar body 94 is held engaged with the locking clip 50, so that the suspender 90 is in a state (locked state) where the suspender 90 is locked. At this time, in the vertical coupling groove portion 30, a whole area of the side face portion 944 of the resin columnar body 94 is placed in a state where the whole area of the side face portion 944 can abut with the side face portion 341 of each positioning projection portion 34. This accordingly makes it possible to precisely perform positioning of the suspender 90 relative to the vertical coupling groove portion 30.

The embodiment thus configured has the following effects. The back cover 13 is attached to the back pad 12 such that the suspender 90 attached to the back surface of the back cover 13 is locked to each of the plurality of locking clips 50 disposed at intervals on the bottom face portion 32 of the vertical coupling groove portion 30. Hereby, it is possible to use the back pad 12 that is obtained in such a simple step of performing insert molding in a state where each of the locking clips 50 is placed at that predetermined position of a molding die for the back pad 12 which corresponds to the bottom face portion 32 of the vertical coupling groove portion 30. That is, a highly accurate machining step of molding an insert wire in a curved shape in advance becomes unnecessary. Further, the suspender 90 is configured such that the resin columnar body 94 to be engaged with each locking clip 50 has flexibility, so that the suspender 90 can be applied to a complicated three-dimensional curved line shape. Accordingly, it is possible to appropriately attach the suspender 90 to that bottom face portion 32 of the vertical coupling groove portion 30 which is a curved line both in a front view and a side view of the back pad 12, thereby making it possible to show a coupling line having a high degree of freedom on the sitting face having a recessed shape. Moreover, the locking clips 50 and the suspender 90 are made of resin or fabric, and thus metal components are not used, thereby making it possible to achieve lightweighting.

A specific embodiment has been described above, but the invention is not limited to the appearances and the configurations described in the above embodiment, and various modifications, additions, and deletes are performable as far as they do not change a gist of the invention. For example, the following modifications are included.

In the above embodiment, the present invention is applied to the seatback 10 of the automotive seat 1. However, the present invention is not limited to this, and can be applied to the seat cushion 2.

In the above embodiment, the suspender 90 configured such that the resin columnar body 94 is attached to one side portion 922, in the longitudinal direction, of the belt-shaped fabric body 92 made of nonwoven fabric is used. However, the present invention is not limited to this, and a suspender in which a columnar portion is provided in one side portion of a resin belt-shaped body may be used.

In the above embodiment, the locking clips 50 are formed integrally with the bottom face portion 32 of the vertical coupling groove portion 30 at the time of molding of the back pad 12. However, the present invention is not limited to this, and the locking clips 50 may be attached by adhesion or the like after the molding of the back pad 12.

In the above embodiment, the present invention is applied to an automotive seat. However, the present invention is not limited to this, and can be applied to seats of a railway vehicle, an airplane, a ship, and the like.

What is claimed is:

1. A vehicle seat comprising:
a seat pad including, on its front surface, a recess-shaped portion with respect to a sitting person; and
a seat cover covering the seat pad and fixed to the recess-shaped portion so as to be tacked into the recess-shaped portion, wherein
the seat pad includes a coupling groove provided on the recess-shaped portion and having a bottom face portion formed on a curved surface extending along a front surface of the recess-shaped portion;
a plurality of locking members is disposed at predetermined positions on the bottom face portion at intervals; and
part of a coupling member attached to a back surface of the seat cover is locked to the plurality of locking members so as to be fixed thereto.

2. The vehicle seat according to claim 1, wherein
the bottom face portion is configured such that its longitudinal central line is a curved line both in a front view and a side view of the recess-shaped portion of the seat pad.

3. The vehicle seat according to claim 1, wherein
the locking members are clips made of resin.

4. The vehicle seat according to claim 1, wherein
the coupling member is a belt-shaped body made of resin or a belt-shaped body in which a resin columnar body is integrally attached, along its longitudinal direction, to one side portion of a belt-shaped fabric body along the longitudinal direction.
